(19) United States
(12) Patent Application Publication
(10) Pub. No.: US 2008/0280006 A1
(43) Pub. Date: Nov. 13, 2008

(54) Protein containing composition produced by cold extrusion

(76) Inventor: Charles I. Onwulata, Cheltenham, PA (US)

Correspondence Address: USDA, ARS, OTT, 5601 SUNNYSIDE AVE, RM 4-1159, BELTSVILLE, MD, 20705-5131, US

(21) Appl. No.: 11/801,868

(22) Filed: May 11, 2007

(51) Int. Cl. A23C 21/00; A23C 9/00; A23J 1/00

(52) U.S. Cl. 426/583; 426/580; 426/656

(57) ABSTRACT

A dietary composition produced by a process involving extruding a protein containing product and optionally water through an extruder at about 50 to about 400 rpm and at a temperature of about −10° to about 30° C. to produce the dietary composition, wherein the undenatured proteins in the protein containing product are not denatured by the process. Preferably some of the denatured proteins in the protein containing product are undenatured (renatured) by the process.

### BACKGROUND OF THE INVENTION

The present invention relates to a dietary composition produced by a process involving extruding a protein containing product and optionally water through an extruder at about 50 to about 400 rpm and at a temperature of about −10° to about 30° C. to produce the dietary composition, wherein the undenatured proteins in the protein containing product are not denatured by the process. Preferably some of the denatured proteins in the protein containing product are undenatured (renatured) by the process.

Extruders provide mechanical and thermal energy for cooking, melting, and forming biomaterials. Extruders can shear and form without heat (Beckett, S. T., et al., The cold extrusion of chocolate, Food Bioprod. Process., 72(C1): 47-54 (1994)). Work on vegetable protein texturization has been conducted since the late 1960s. The benefit of the use of extrusion for stretching or texturizing plant proteins to impart fibrous texture for use as meat extenders was recognized in U.S. Pat. No. 3,488,770. The conditions needed for texturization, the effects of extrusion processing on elasticity, density, and fiber formation have been characterized for vegetable proteins. Soy isolates are mostly processed at high moisture at temperatures above 150° C. (Kitabatake, N., et al., J. Food Sci., 50: 453-458 (1985)). The main characteristic of this process is formation of extrusion-shear-induced fibrous networks formed through disulfide bonds, and cross-linking of protein chains through amide bonds between free-carboxyl and amino side groups on the protein chains (Harper, J. M., Extrusion of Foods, Vol. 1, 1981, CRC Press, Boca Rotan, Fla.). Similar processes involving shear and heat have been applied for texturizing whey proteins (Hale, A. B., et al., J. Food Sci., Vol. 67(3): 1267-1270 (2002); Onwulata, C. I., and P. M. Tomasula, Food Technol., 58(7): 50-54 (2004)).

The technology of cold extrusion cooking is relatively new and the literature on cold extrusion is extremely limited (Beckett, S. T., et al., 1994; Osbourn, W. N., et al, Utilization of twin screw cold extrusion to manufacture restructured chops from lower-valued pork, University of Nebraska, College of Agriculture Extension and Home Economics Bulletin, #94-219-A, p. 23-37 (1995); Cho, M. H., et al., Production of natural flavors using a cold extrusion process, ACS Symposium Series 610, ACS, Washington, D.C., 1995, p. 120-128).

I have found that non-thermal extrusion creates new structures and functions for proteins (e.g., whey protein isolate) that forms specifically structured or texturized cross-linked protein fibers that can be used as spongy cake-like product or as ingredients in foods.

### SUMMARY OF THE INVENTION

In accordance with the present invention, there is provided a dietary composition produced by a process involving extruding a protein containing product and optionally water through an extruder at about 50 to about 400 rpm and at a temperature of about −10° to about 30° C. to produce the dietary composition, wherein the undenatured proteins in the protein containing product are not denatured by the process. Preferably some of the denatured proteins in the protein containing product are renatured by the process.

### BRIEF DESCRIPTION OF THE DRAWINGS

FIG. 1 is a photo showing (A) cold extruded whey dough containing only whey protein isolates and water, and (B) the baked cold extruded whey product described below.

FIG. 2 is a photo showing: Top row A, B, C show samples of cold extruded or texturized dough extruded at 5°, 15° and 20° C. (described below); Bottom row baked cold extruded, tekturized dough extruded at 5°, 15° and 20° C. (D, E, F, respectively).

FIG. 3 shows Confocal Laser Scanning Micrographs: Top row A, B, C show the samples before baking (described below); Bottom row D, E, F show baked samples of cold extruded, texturized dough extruded at 5°, 15° and 20° C. (described below).

### DETAILED DESCRIPTION OF THE INVENTION

The present invention relates to a dietary composition produced by a process wherein the proteins in a protein containing product (e.g., milk protein containing product such as milk, milk concentrate, milk protein concentrate, whey, whey concentrate, preferably whey protein isolate) are extruded through an extruder (e.g., single screw extruder, preferably twin screw extruder) at low shear (generally about 50-about 400 rpm (e.g., 50-400 rpm), preferably about 50-about 350 rpm (e.g., 50-350 rpm), more preferably about 50-about 300 rpm (e.g., 50-300 rpm)) at a temperature in the extruder of about −100 to about 30° C. (e.g., −10° to 30° C.; preferably about 0° to about 25° C. (e.g., 0° to 25° C.)). Pressures may range from about 0 to about 2000 psi (e.g., 0-2000 psi; preferably about 0 to about 100 psi (e.g., 0-100 psi), more preferably about 0 to about 50 psi (e.g., 0-50 psi)), and torque may range from about 20 to about 80% (e.g., 20-80%; preferably about 35 to about 60% (e.g., 35-60%)). Residence time of the protein containing product in the extruder is generally about 15-about 120 seconds (e.g., 15-120 seconds; preferably about 30-about 90 seconds (e.g., 30-90 seconds), and more preferably about 45-about 90 seconds (e.g., 45-90 seconds)).

The undenatured proteins in the protein containing product are not denatured during the process. In addition, some of the naturally denatured proteins that occur in the protein containing product are undenatured (renatured) during the process. Generally, at least about 10% (e.g., at least 10%) of the naturally denatured proteins that occur in the protein containing product are undenatured (renatured) during the process, preferably at least about 20% (e.g., at least 20%), preferably at least about 30% (e.g., at least 30%), preferably at least about 40% (e.g., at least 40%), preferably at least about 50% (e.g., at least 50%), more preferably at least about 60% (e.g., at least 60%), preferably at least about 70% (e.g., at least 70%); generally, up to about 80% (e.g., up to 80%) of the naturally denatured proteins that occur in the protein containing product are undenatured (renatured) during the process.

As noted above, the protein containing product may be a milk protein containing product such as milk, milk concentrate, milk protein concentrate, whey, whey concentrate, or preferably whey protein isolate (WPI). Whey proteins can differ dramatically from one another depending on the processing method. Whey protein can exist as simple whey powder (30% or less total protein content), whey protein concentrate (30-85% protein) or whey protein isolate (90% or higher protein content). Whey protein isolate is the purest form of whey protein; it contains little or no fat or lactose. The United States' Department of Agriculture has specified that dry whey protein concentrate shall contain not less than 25% or more than 89.9% protein. Other ingredients (e.g., other proteins from plant or animal sources, starch, sweeteners, leavening agents) may be added to the protein containing product before or after the extrusion. Other ingredients may be any food ingredient. For example, the food ingredient may be the ingredients for cakes or meats or any other food. Furthermore, the food ingredient may be shelf-stable packaged pre-mixes for preparing food and beverage compositions, usually requiring the addition of other ingredients (e.g., eggs, shortening, water or milk) to be supplied and added by the preparer. Additionally, the food ingredient may be a ready-to-cook mix (combined food ingredients that require additional cooking (e.g., baking, frying, micro waving) to form a ready-to-eat food or beverage product). The resulting product may be any food product such as a drink, yogurt, or pizza, or a bakery product such as cake, biscuit, pie crust, cookie, muffin, bread, cereal, doughnut, noodle, brownie, cracker or snack food. The amount of the dietary composition contained in the food product may be any amount that does not adversely affect the food product (for example, the food product may contain about 1% to about 80% of the dietary composition, preferably about 5% to about 60%, more preferably about 5% to about 40%, most preferably about 15% to about 30%).

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Extrusion Processing: Whey protein isolate (Provon 190® purchased from Glanbia Ingredients (Glanbia Foods Inc., Twin Falls, Id.) was used for the work. The barrel temperature profile for extrusion was set to the following: 20° C. for the first five zones of the extruder, and the last four zones were set adiabatically to either 30°, 25°, 20°, 15°, 10°, or 5° C., respectively, from the feed section to the die. Water (room temperature) input to the extruder was at rates ranging from 5.0 to 6 L/hr. Feed rates varied for the three experiments from 7.3 to 8.8 kg/hr. The APV Baker MPF50 co-rotating screw extruder (APV Baker, Grand Rapids, Mich.) was used for this study. Extruder die pressure was at 50 psi; torque reading was 30%. The screw speed of the extruder was maintained at 300 rpm. The screw elements were selected to provide low shear at 300 rpm by using mostly conveying screws in the first five zones. The extrusion was with minimal shear between 100 to 350 rpm, providing longer residence time (i.e., 90-120 seconds) for the proteins in the extruder. The cold extruded, stretched and aligned or texturized protein was immediately baked in an oven at 140° C. for 25 to 30 min. The cold extruded, stretched and aligned or texturized protein dough can also be dried to less than 8% moisture and stored until needed, and can be rehydrated to form whey dough. As the proteins will degrade over time, samples were collected and stored at −22° C. for further analysis.

Moisture content was measured as per method #925.09, AOAC, 1998, using a vacuum oven.

Protein was determined with 0.2 g extrudate analyzed with a LECO Nitrogen Analyzer Model FP2000 (LECO Corporation, St. Joseph, Mich.). Percent protein was calculated with the nitrogen conversion factor 6.38 for whey protein.

Determination of solubility and denaturation of extruded whey protein isolates: 1.0 g sample of extrudate was added to a 250-ml beaker and 90 ml of deionized water was added. The protein suspension was stirred at 125 rpm at pH 7.0 for 2 hours. Samples were then centrifuged for 20 minutes and the supernatant was freeze dried overnight. The LECO Nitrogen Analyzer was used to analyze the solids from the supernatant for protein content. The nitrogen/protein conversion factor was 6.38 and percent solubility and denaturation was calculated as described by Kilara (Kilara, A., J. Dairy Sci., 67: 2734-2744 (1984). Percent protein denatured was calculated as: (% Protein−% Solubility).

Protein Digestibility was determined with 10 ml extrudate sample dissolved in distilled water, the pH was adjusted to 8.0 with 0.1 N NaOH or HCl. One milliliter of freshly prepared enzyme stock solution (1.6 mg/ml trypsin, 3.1 mg/ml chymotrypsin, and 1.3 mg/ml aminopeptidase) was added to the protein suspension at 37° C. The pH after 10 min was recorded, and a Tris/HCl buffer containing 2.0% SDS (w/v) and 0.1% mercaptoethanol (v/v) was added to the protein solution which was immediately heated to 90° C. to terminate the enzymatic reaction. Samples were then analyzed by quantitative gel electrophoresis. The % protein digestibility was calculated by the following equation: % Digestibility=210.46−18.10(X); where X is the pH (Singh, H., and L. K. Creamer, J. Food Sci., 53(2): 299-302, 306 (1993)).

Fluorescence Microscopy: Segments of extruded ribbons were immersed in 2.5% glutaraldehyde-0.1M imidazole buffer solution and stored in sealed vials. For imaging, cross-sections of the ribbons were cut with a stainless steel razor blade. Whole mounts were oriented with the cut surface oriented vertically on the stage of a model MZ FLIII stereo-fluorescence microscope (Leica Microscopy Systems Ltd., Wetzlar, Germany) and illuminated with a filter set for green autofluorescence. Digital images of general fluorescence from the acid, neutral and alkaline extrudates were obtained using an integrated charge couple device camera system. Higher resolutions images of the same samples were obtained by confocal imaging; each cut section was mounted over the coverslip area of a glass bottom Petri dish (MatTek Corp., Ashland, Mass.). Images of green autofluorescence (500-550 nm) arising from glutaraldehyde-protein complexes was excited at 488 nm using a SP laser scanning confocal microscope (Leica Microsystems, Wetzlar, Germany) equipped with a 20× objective lens

Results: Cold extruded whey protein isolates ranged in moisture from 40 to 64% depending on the solids to liquid ratio at a given temperature (Table 1). As extrusion time increased, with process temperature going down from 30° C. to 5° C., the ratio of whey protein to water increased; more whey protein was mixing with the cooling water (at 5° C., or 10° C. , or 15° C., or 20° C., or 25° C.) depending on the desired setpoint conditions. Without being bound by theory, the cooling water did not flow as readily in the extruder. This phenomenon was the same either for decreasing moisture content or increasing whey protein content for all three experiments conducted over a two year period (Tables 1-3).

The protein content was not changed by the cold extrusion processing; the values ranged from 89.1 to 94.9%. These values are within the range specified for whey protein isolates which by Code of Federal Regulations are required to contain at least 90% protein.

Protein solubility was not changed but was surprisingly seen to increase over the control from 2 to 24% for all three experiments. Solubility is a test designed to determine the extent of denaturation or change in conformation of proteins from the soluble native state to the insoluble denatured state. Denaturation is usually calculated as 100−percent soluble. Spray dried commercial whey protein isolates (which are about 15-25% denatured in their powdered state) started with 73.4% soluble, but surprisingly ended up after cold extrusion with increased solubility ranging from 9 to 25% (Tables 1-3); in denaturation terms, the cold extruded whey proteins surprisingly reversed the norm which is to increase denaturation with shear and temperature. With cold extrusion, moderate shear and sub-ambient temperatures, surprisingly no new denaturation was observed; furthermore, commercial whey protein isolates surprisingly became even less denatured (renatured) after cold extrusion.

Initially, protein digestibility tests were done to determine if cold extrusion conditions changed digestion of the proteins. From the results, digestibility was not affected as all three experiments show values greater than 80%. There were differences based on temperature of extrusion, but all values were within the protein digestibility range of 87.5%+/−6.4.

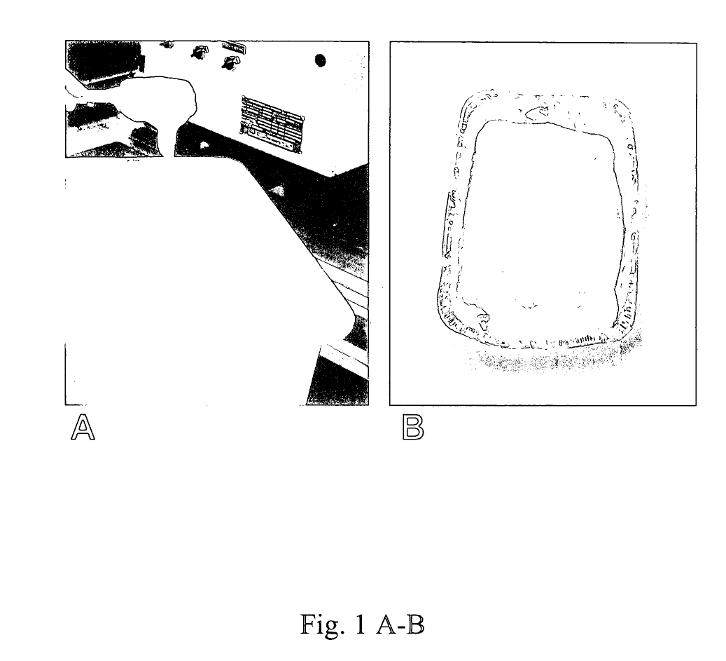

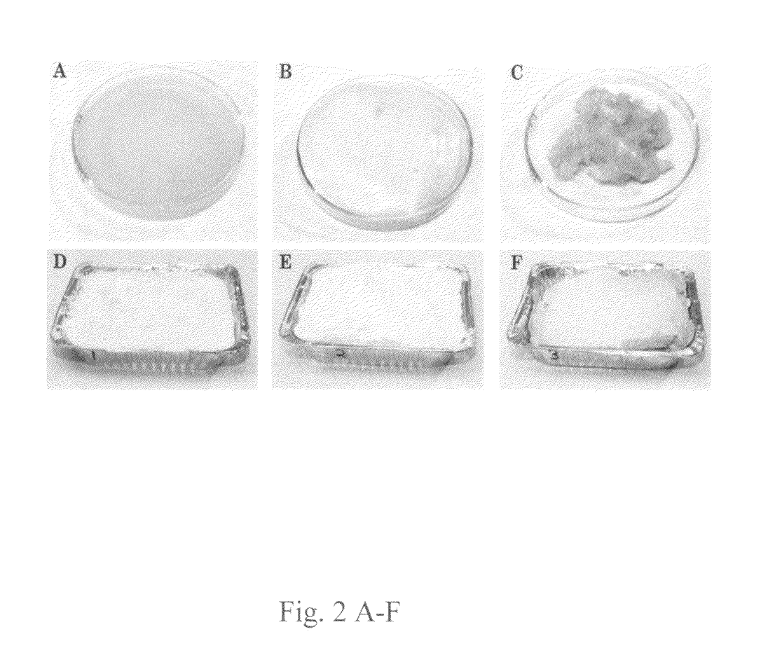

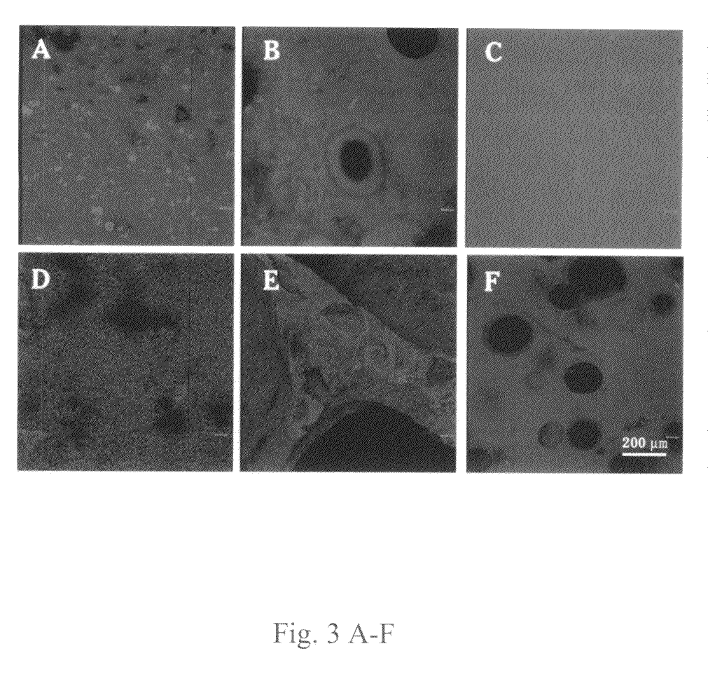

I have discovered that cold extruded whey protein isolates formed “protein-dough.” This protein-dough (FIG. 1A) was baked at 140° C. for 30 min (FIG. 1B). Various types of whey protein isolate gels were made depending on the cold extrusion temperature (FIG. 2). The top panel of FIG. 2 (A, B, C) shows cold extruded whey protein dough at 5°, 15°, and 20° C., and the lower panel shows their corresponding baked products (D, E, F). After baking, the moisture content of the resulting all-protein cake was determined (Table 3). The moisture of baked whey protein isolate cakes ranged from 43 to 60%, corresponding to initial un-baked product moisture content (Table 3), thus not much moisture was lost in the baking process. Confocal laser scanning images of the gels and their baked products (FIG. 3) showed distinct angel cake-like structures before and after baking. Comparing the top panel, whey isolates gels which had been extruded at 5° C. (A), 15° C. (B) or 20° C. (C) showed structures with crystalline features embedded at 5° C., less crystalline structures with air vacuole at 15° C., and a mostly clear paste with very few crystalline structures at 20° C. The baked products were also distinct, with 5° C. whey-cake having uniformly spaced network structures (D) with 20 μm sized lattices, the 15° C. whey-cake (E) with a more compact bread-like mass with larger air pockets, and the 20° C. baked whey-cake product with a smooth cheese-like structure with many air vacuoles (F).

Discussion: In the unfolding of whey proteins during conventional extrusion processes, particularly its two main fractions, beta lactoglobulin (β-Lg) and alpha-lactalbumin (α-La), are irreversibly unfolded. Traditionally, prior to this invention, thermal extrusion induced unfolding effects from direct shear-generated heat input leading to loss of solubility and thus increased denaturation with increasing pH. Whey proteins can be modified using chemicals, heat, or by shear in extrusion processes. Chemical treatment alone alters the reactive groups of the amino acids, resulting in changes in the noncovalent forces that influence conformation such as van der Waals forces, electrostatic interactions, hydrophobic interactions, and hydrogen bonding (Kester, J. J., and T. Richardson, J. Dairy Sci., 67(11): 2755-2774 (1984)). Combining heating and shear alters the conformational structure of the protein through some denaturation of the protein, exposing groups that are normally concealed in the native protein.

The present study is the first to show that by stretching and aligning (or texturization) of whey protein isolates at cold temperature extrusion conditions that commercial whey isolate powder can surprisingly increase solubility, reverse denaturation (renaturation), and form dough-like gels that bake into angel cake-type structure by combining cold temperatures and shear. The present study showed that with only the addition of shear in the extruder, significant change of state and conformation can occur much below 30° C. Cold extrusion texturization occurred in the short time order of 45 to 90 sec within the extruder, permitting cold extrusion texturized WPI to maintain its biological nutritive conformational quality, providing new functionality such as to function as whey dough and baking into whey cake. The network structure in a cold induced globular gel depends strongly on the effect of shear disruption and hydrophobicity balance. Structural transitions are reflected as the macrostructural states of gels (FIG. 2A), foams (FIG. 2B), and sticky fibrous taffy-like product (FIG. 3C). These structures fluoresce as very fine-stranded gels with particulates (FIG. 3A), the foamy gels with less particulates but prominent central void (FIG. 3B), and the doughy pastes as particularly glossy (FIG. 3C).

I have thus shown that the combination of extrusion shear and cold temperatures less than 30° C. produced textures that behave differently from those produced from temperatures greater than 50° C. One example was its immediate effect on solubility: reversing the partially denatured state (in other words renaturation) of commercial whey isolates (which are ˜25% denatured or 75% soluble) and thus increasing their solubility to ≧90% soluble or <10% denatured). Secondly, the cold shear textured proteins were dough-like semi-crystalline masses (FIGS. 3A & 3B), and thirdly, they baked into foamy cake-like products with air vacuoles (FIGS. 3D, 3E, and 3F). Specialty products rich in nutrients are needed to combat the growing world-wide epidemic in obesity and its attendant health risks such as diabetes. Novel ingredients made from stretched or cold textured whey proteins of the present invention can play a big role in providing nutrient-rich ingredients that can be included in products such as snacks, cakes, and meats. This invention introduces a new ingredient and product which can enhance existing ingredients and products on the market and/or result in whole new applications-based health products. This new product provides energy from a non-carbohydrate or non-sugar source, and is a totally new concept in the pastry or baked goods segment. Its use and market potential would be very valuable, especially in new heart-healthy foods market segments because of the many advantages it offers, particularly as a significant source of protein and other nutrients, and as a non-carbohydrate based source of baked good. This product is value added, and will increase market for dairy ingredients.

All of the references cited herein, including U.S. Patents, are incorporated by reference in their entirety. Also incorporated by reference in their entirety are the following: U.S. Pat. No. 3,488,770; Beckett, S. T., et al., Food Bioprod. Process., 72(C1): 47 54 (1994); Berry, D., Prepared Foods, 169(7): 67-68, 70, 72 (2000); Bryant, C. M., and D. J. McClements, Trends in Food & Technology, 9: 143-151 (1998); Cho, M. H.,et al., Production of natural flavors using a cold extrusion process, ACS Symposium Series 610, ACS, Washington, D.C., 1995, p. 120-128; Ennis, M. P., and D. M. Mulvhill, Milk proteins, pages 189-217 in Handbook of Hydrocolloids, Eds G. O. Phillips and P. A. Williams, 2000, CRC Press. Boca Rotan, Fla.; Farrell, H. M., Jr., et al., J. Dairy Sci., 85: 459-471 (2002); Gezimati, J., et al., J. Agric. Food Chem., 45(4): 1130-1136 (1997); Gogoi, B. K., et al., Int. J. Food Properties, 3(1): 37-58 (2000); Hale, A. B., et al., J. Food Sci., 67(3): 1267-1270 (2002); Harper, J. M., Extrusion of Foods, Vol. I, 1981, CRC Press, Boca Rotan, Fla.; Ikeda, S., and V. J. Morris, Biomacromolecules, 3: 382-389 (2002); Ju, Z. Y., and A. Kilara, J. Food Sci., 63(2): 288-292 (1998); Kavanagh, G. M., et al. 28(2000):41-50; Kester, J. J., and T. Richardson, J. Dairy Sci., 67(11): 2755-2774. (1984); Kilara, A. J. Dairy Sci., 67: 2734-2744 (1984); Kitabatake, N., et al., J. Food Sci., 50: 453-458 (1985); Kunugi, S., and N. Tanaka, Biochemica et Biophysica Acta., 1595: 329-344 (2002); Onwulata, C. I., and P. M. Tomasula, Food Technol., 58(7): 50-54 (2004); Osbourn, W. N., et al., Utilization of twin screw cold extrusion to manufacture restructured chops from lower-valued pork, University of Nebraska, College of Agriculture Extension and home Economics Bulletin, #94-219-A, p. 23-37 (1995); Reifsteck, B. M., and I. J. Jeon, Food Rev. Int., 16(4): 435-452 (2000); Singh, H., and L. K. Creamer, J. Food Sci., 53(2): 299-302, 306; Walstra, P., et al., pages 189-199 in Dairy Technology: Principles of Milk Properties and Processes, Walstra, T. J., et al., ed., 1999, Marcel Dekker, Inc., New York.

Also incorporated by reference in their entirety are the following U.S. patent application Ser. No. 10/686,834, filed 16 Oct. 2003; Ser. No. 10/767,979, filed 29 Jan. 2004; Ser. No. 11/487,802, filed 17 Jul. 2006. Also incorporated by reference in their entirety are the following U.S. Patent Application Publications: 2006/0292287; 2005/0084579; 2005/0084578. Also incorporated by reference in their entirety are the following U.S. Pat. No. 6,610,347.

Thus, in view of the above, the present invention concerns (in part) the following:

A dietary composition produced by a process comprising (or consisting essentially of or consisting of) extruding a protein containing product (and water (optionally)) through an extruder at about 50 to about 400 rpm and at a temperature of about −10° to about 30° C. to produce said dietary composition, wherein the undenatured proteins in said protein containing product are not denatured by said process.

The above dietary composition, wherein at least about 10% of the denatured proteins in said protein containing product are renatured by said process or wherein at least about 20% of the denatured proteins in said protein containing product are renatured by said process or wherein at least about 30% of the denatured proteins in said protein containing product are renatured by said process or wherein at least about 40% of the denatured proteins in said protein containing product are renatured by said process or wherein at least about 50% of the denatured proteins in said protein containing product are renatured by said process or wherein at least about 60% of the denatured proteins in said protein containing product are renatured by said process or wherein at least about 70% of the denatured proteins in said protein containing product are renatured by said process.

The above dietary composition, wherein said protein containing product is selected from the group consisting of milk, milk concentrate, milk protein concentrate, whey, whey concentrate, whey protein isolate, whey protein concentrate, and mixtures thereof. Wherein said protein containing product is selected from the group consisting of whey concentrate, whey protein isolate, whey protein concentrate and mixtures thereof. Wherein said protein containing product is whey protein isolate.

The above dietary composition, wherein said process does not involve the addition of monosaccharides.

The above dietary composition, wherein said process does not involve the addition of polysaccharides.

The above dietary composition, wherein said process does not involve the addition of carbohydrates.

The above dietary composition, wherein said process does not involve the addition of or starch.

The above dietary composition, wherein the residence time of said protein containing product in said extruder is about 15 to about 120 seconds or about 30 to about 90 seconds or about 45 to about 90 seconds.

The above dietary composition, wherein said temperature is about 0° to about 25° C.

A food product comprising at least one food ingredient and the above dietary composition.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Physical Properties of Cold Extruded Whey Protein Isolates

| Property | Extrusion Temperature (° C.) | | | |
|---|---|---|---|---|
| (%) | 25 | 15 | 10 | 5 |
| Moisture | 63.6 ± 0.1 | 54.1 ± 0.7 | 45.0 ± 1.1 | 40.7 ± 0.9 |
| Protein | 91.7 ± 0.3 | 89.7 ± 1.0 | 91.8 ± 0.3 | 92.3 ± 0.2 |
| Solubility | 80.0 ± 6.4 | 77.9 ± 2.4 | 74.9 ± 14.8 | 78.4 ± 5.1 |
| Digestibility | 87.3 ± 7.2 | 86.9 ± 2.7 | 81.5 ± 16.0 | 85.1 ± 5.7 |

TABLE 2
Physical Properties of Cold Extruded Whey Protein Isolates

| Property | Extrusion Temperature (° C.) | | | | | |
|---|---|---|---|---|---|---|
| (%) | 30 | 25 | 20 | 10 | 5 | Native |
| Moisture | 66.9 ± 5.4 | 63.1 ± 1.5 | 59.6 ± 0.4 | 59.5 ± 0.1 | 58.8 ± 0.0 | 1.39 ± 0.2 |
| Protein | 83.4 ± 0.9 | 86.6 ± 1.9 | 91.2 ± 0.2 | 85.8 ± 0.0 | 84.7 ± 0.3 | 89.1 ± 0.6 |
| Solubility | 87.5 ± 3.1 | 85.1 ± 9.9 | 92.1 ± 5.1 | 88.5 ± 7.0 | 82.7 ± 4.0 | 73.4 ± 0.7 |

TABLE 3
Physical Properties of Cold Extruded Whey Protein Isolates

| Property | Extrusion Temperature (° C.) | | |
|---|---|---|---|
| (%) | 20 | 10 | 5 |
| Moisture | 64.6 ± 0.6 | 55.5 ± 0.1 | 42.9 ± 0.1 |
| Protein | 94.9 ± 0.2 | 89.6 ± 0.3 | 94.1 ± 0.3 |
| Solubility | 79.7 ± 7.3 | 84.6 ± 1.6 | 84.1 ± 3.4 |
| Baked Product* | 60.4 ± 0.8 | 55.1 ± 0.3 | 43.0 ± 0.2 |

Baked Product* (FIG. 1B)

I claim:

1. A dietary composition produced by a process comprising extruding a protein containing product and optionally water through an extruder at about 50 to about 400 rpm and at a temperature of about −10° to about 30° C. to produce said dietary composition, wherein the undenatured proteins in said protein containing product are not denatured by said process.

2. The dietary composition according to claim 1, wherein at least about 10% of the denatured proteins in said protein containing product are renatured by said process.

3. The dietary composition according to claim 1, wherein at least about 20% of the denatured proteins in said protein containing product are renatured by said process.

4. The dietary composition according to claim 1, wherein at least about 30% of the denatured proteins in said protein containing product are renatured by said process.

5. The dietary composition according to claim 1, wherein at least about 40% of the denatured proteins in said protein containing product are renatured by said process.

6. The dietary composition according to claim 1, wherein at least about 50% of the denatured proteins in said protein containing product are renatured by said process.

7. The dietary composition according to claim 1, wherein at least about 60% of the denatured proteins in said protein containing product are renatured by said process.

8. The dietary composition according to claim 1, wherein at least about 70% of the denatured proteins in said protein containing product are renatured by said process.

9. The dietary composition according to claim 1, wherein said protein containing product is selected from the group consisting of milk, milk concentrate, milk protein concentrate, whey, whey concentrate, whey protein isolate, whey protein concentrate, and mixtures thereof.

10. The dietary composition according to claim 1, wherein said protein containing product is selected from the group consisting of whey concentrate, whey protein isolate, whey protein concentrate and mixtures thereof.

11. The dietary composition according to claim 1, wherein said protein containing product is whey protein isolate.

12. The dietary composition according to claim 1, wherein said process does not involve the addition of monosaccharides.

13. The dietary composition according to claim 1, wherein the residence time of said protein containing product in said extruder is about 15 to about 120 seconds.

14. The dietary composition according to claim 1, wherein the residence time of said protein containing product in said extruder is about 30 to about 90 seconds.

15. The dietary composition according to claim 1, wherein the residence time of said protein containing product in said extruder is about 45 to about 90 seconds.

16. The dietary composition according to claim 1, wherein said temperature is about 0° to about 25° C.

17. A food product comprising at least one food ingredient and the dietary composition according to claim 1.
